(19) United States
(12) Patent Application Publication
(10) Pub. No.: US 2021/0004182 A1
(43) Pub. Date: Jan. 7, 2021

(54) STARVATION PREDICTIONS BASED ON CONVERSION METRICS

(71) Applicant: Hewlett-Packard Development Company, LP., Spring, TX (US)

(72) Inventors: Leslie Caroline Drogo, San Diego, CA (US); Frank Perdicaro, Corvallis, OR (US)

(73) Assignee: Hewlett-Packard Development Company, LP., Spring, TX (US)

(21) Appl. No.: 16/965,036

(22) PCT Filed: Mar. 29, 2018
(86) PCT No.: PCT/US2018/025190

§ 371 Date: Jul. 27, 2020

(51) Int. Cl. G06F 3/12

(52) U.S. Cl. CPC G06F 3/121; G06F 3/1282; G06F 3/1219; G06F 3/1245

(57) ABSTRACT

An example of an apparatus including a front-end engine to receive document data in a first format for printing via a network. The apparatus includes a conversion engine in communication with the front-end engine. The conversion engine is to carry out a conversion of the document data from the first format to an uncompressed format, wherein the conversion engine generates metrics associated with the conversion. The conversion engine parses the document data in the uncompressed format into a plurality of separations. The apparatus includes a compression engine to process a separation of the plurality of separations from the uncompressed format to a second format, wherein the second format is a predetermined format associated with a printing device. The apparatus includes a print engine controller to transmit the separations in the second format to the printing device, wherein the print engine controller uses the metrics to predict a starvation condition.

### BACKGROUND

Printed documents are often used to present information. In particular, printed documents continue to be used despite the availability of electronic alternatives as they are more easily handled and read by users. Accordingly, the generation of printed documents as well as conversion of printed documents to electronic form remain important tools for the presentation and handling of information. Printing devices are known and have been used to generate documents. Printing devices range from desktop printers capable of printing documents from a personal computer to printing presses that may print large volumes of material at high speeds for subsequent distribution.

### BRIEF DESCRIPTION OF THE DRAWINGS

Reference will now be made, by way of example only, to the accompanying drawings in which:

FIG. 1 is a block diagram of an example apparatus to operate a printing press using a starvation prediction based on a conversion metric;

FIG. 2 is a flowchart of an example of a method to operate a printing press using a starvation prediction based on a conversion metric;

FIG. 3 is a block diagram of a system with an example controller to predict starvation at an example printing device;

FIG. 4 is representation of document data processed by an example apparatus to predict starvation; and

FIG. 5 is representation of document data processed by another example apparatus to predict starvation.

### DETAILED DESCRIPTION

Printed documents may be widely accepted, and may often be more convenient to use. In particular, printed documents are easy to distribute, store, and be used as a medium for disseminating information. In addition, printed documents may serve as contingency for electronically stored documents, such as may happen when an electronic device fails, such as with a poor data connection for downloading the document and/or a depleted power source. In some applications, large volumes of documents are to be generated, such as for distribution of marketing materials or for generating invoices or statements for a large number of clients. In such cases, printing devices such as printing presses may be used to generate a large amount of documents via high speed printing.

Printing press systems typically include an image pipeline to receive data files from various sources over a network. Since printing presses operate at high speeds, such as moving paper at about 1000 feet per minute, unexpectedly stopping a printing press in motion may create mechanical issues as well as generate a large amount of waste as the machine slows down to a stop. Accordingly, the image pipeline continuously feeds content to the printing press such that the machinery does not stop. Since the processing of the document data varies, it is possible that a starvation condition occurs which may leave the printing press with no content to print. To reduce the likelihood of a starvation condition the image pipeline generally includes a buffer to store content for feeding to the printing press.

In some situations, the image pipeline experiences difficulty processing a data file. For example, the data file received at the image pipeline may include content that is computationally intensive such that decompressing the data file and/or recompressing the raw raster may use more than the typically allotted amount of time. Accordingly, this may generate a starvation condition at the printing press.

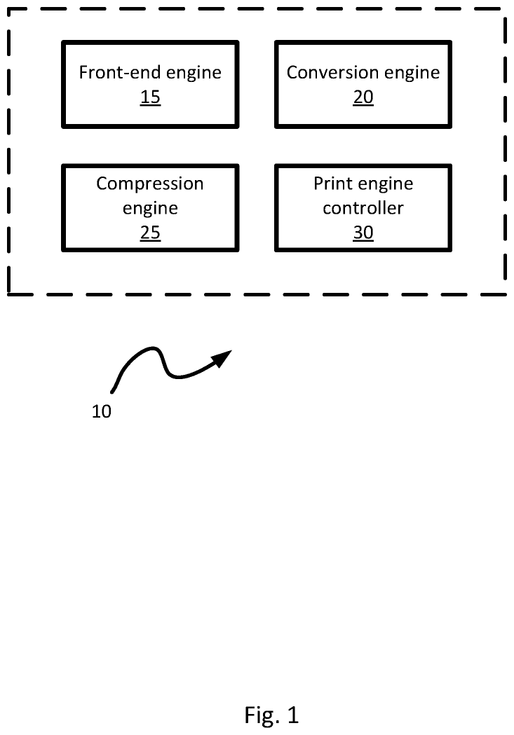

Referring to FIG. 1, an apparatus to operate a printing press is shown at 10. The apparatus 10 may include additional components, such as various additional interfaces and/or displays to interact with a user or administrator of the apparatus. The apparatus 10 is to operate an image pipeline by receiving and processing data, such as document data from a source and controlling a printing device, such as a printing device, to generate documents. In the present example, the apparatus 10 includes a front-end engine 15, a conversion engine 20, a compression engine 25, and a print engine controller 30.

The front-end engine 15 is to receive document data for printing. In the present example, the document data is received via a network. Accordingly, the front-end engine 15 may include a communications device (not shown), such as a network interface card or wireless antenna, to receive document data. In the present example, the communications device may communicate with a network, such as the Internet or a local network, and receive data via the network. The network may provide a link to another device, such as a content provider, a personal computer, a mobile computing device, or any other device from which document data may be generated.

The manner by which the front-end engine 15 receives document data is not limited and in other examples, the front-end engine 15 may directly receive document data such as from a memory storage device connected to a user terminal. Therefore, the communications device may also include a universal serial bus (USB) port, a serial port, a parallel port, a wired network adaptor, a wireless network adaptor, or similar for other examples.

In the present example, the format of the document data received is not particularly limited. For example, the document data may be a page-oriented data file representing a plurality of pages to be printed, such as a portable document file (PDF) where the pages of the document data are interrelated. Other suitable example document formats include PostScript (PS), Extensible Markup Language Paper Specification (XPS), Advanced Function Presentation (AFP), and Printer Command Language (PCL). For example, the pages may be sequential, or the pages may be odd or even pages. In some examples, the front-end engine 15 may also parse the document data into a plurality of chunks prior to forwarding the document data to the next portion of the image pipeline. Accordingly, each chunk may include a plurality of pages and represent a unit of work in some examples. In the other examples, the document data may be a chunk in its entirety.

The conversion engine 20 is in communication with the front-end engine 15. After receiving the document data, the front-end engine 15 may pass the document data directly to the conversion engine 20. In some examples, the front-end engine 15 may pre-process the document data or divide the document data into chunks. Once the conversion engine 20 receives the document data, the conversion engine 20 is to carry out a conversion of the document data from the received format, such as the page-oriented format, to an uncompressed format, such as raw image format or a raster file format. This may be referred to as raster image processing or RIPping. It is to be appreciated that the uncompressed format is not particularly limited and may include Tagged Image File Format (TIFF), lossless Joint Photographic Experts Group (JPEG), lossless PS, a PDF image, and other lossless formats.

In the present example, the conversion engine 20 generates metrics associated with the conversion process of the document data from the page-oriented format to the uncompressed format. For example, the metrics may include the time used by the conversion engine 20 to convert the document data, or chunk of document data, from the page-oriented format to the uncompressed format and raster size. In other examples, the metrics may include the compression ratio of the page-oriented format, the amount of memory used in the conversion process, or the amount of processor resources used.

Once generated, the metrics may be transmitted to the print engine controller 30. Alternatively, the print engine controller 30 may periodically request the metrics from the conversion engine 20. In other examples, the metrics measured at the conversion engine 20 may be combined with other metrics, such as from the compression engine 25 discussed below prior to being transmitted to the print engine controller 30.

After converting the document data to an uncompressed format, the conversion engine 20 separates the document data into a plurality of separations. In the present example, a separation from the plurality of separations is a portion of a page. Accordingly, each page of the document data includes a list of separations. The manner by which the page is divided into separations and the number of separations used are not limited. For example, the number of separations produced may be a function of the physical configuration of the printing press and a desired print quality and fidelity. For example, a low-quality job may be done in black and white at low resolution. Higher quality may demand more separations, and more separations tend to provide a wider color gamut and better visual appeal. Selection a separation count may include consideration of cost, time, and efficiency. The greater the number of separations used, the greater the effect of optimization in the image pipeline, as may be provided by the techniques described herein.

The compression engine 25 is to process the separations created by the conversion engine 20. In particular, the compression engine 25 is to convert the separations in the uncompressed format to another format that is associated with a printing device to which the separation is to be transmitted for printing. The format is not particularly limited and may be predetermined based on the known format or formats that are associated with the printing device. In the present example, the format associated with the printing device is a lossy compression format tuned to human vision. It is to be appreciated that a lossy compression is used to reduce the amount of storage consumed as well as additional hardware to handle the compressed separations. In particular, the present example uses an Indigo Compression Format or ICF, for the printing device. Other example lossy compression formats usable for the printing device include JPEG and Joint Bi-level Image Experts Group (JBIG). It is to be appreciated that this format associated with the printing device is not particularly limited. In other examples, the format associated with the printing device may include Snappy, zlib, or similar format which may be used to measure information density of an image. For example, a blank page or a page with little information may undergo a high degree of compression, and such a format may be selected to measure how quickly the pipeline may move such images. In various examples, multiple forms of compression, such as ICF and Snappy/zlib, may be used on the same page.

In some examples, the compression engine 25 may also generate metrics associated with the compression process of the separations from the uncompressed format to the format associated with the printing device. For example, the metrics may include the time used by the compression engine 25 to convert each separation, or a plurality of separations representing a chunk of the document data, from the uncompressed format to the format associated with the printing device. In other examples, the metrics may include the compression ratio of the format associated with the printing device, the amount of memory used in the conversion process, the amount of processor resources used, an elapsed processing time, or a ratio of compressed size to original size.

Once generated, the metrics from the compression engine 25 may be transmitted to the print engine controller 30. Alternatively, the print engine controller 30 may periodically request the metrics from the compression engine 20. In other examples, the metrics measured at the compression engine 25 may be combined with other metrics, such as metrics from the conversion engine 20 and aggregated prior to being transmitted to the print engine controller 30.

The print engine controller 30 is to transmit the separations which have been converted to the format associated with the printing device. In the present example, the print engine controller 30 is to send the separations to the printing device where the printing device generates output corresponding to the separations. In the present example, the separations are transmitted to the printing device via a network. Accordingly, the print engine controller 30 may include a communications device (not shown), such as a network interface card or wireless antenna, to receive document data. In the present example, the communications device may communicate with a network, such as the Internet or a local network, and transmit data via the network.

The manner by which the print engine controller 30 transmits document data to the printing device is not limited and in other examples, the print engine controller 30 may directly transmit document data such as via a universal serial bus (USB) port, a serial port, a parallel port, a wired network adaptor, a wireless network adaptor, or other examples.

Furthermore, the print engine controller 30 is to predict a starvation condition at the printing device. A starvation condition occurs when the print engine controller 30 does not have any separations or document data to send to a printing device in motion. In particular, if the print engine controller 30 has no more data to send to the printing device, the printing device will face an error condition where there is nothing to be printed. In some examples, the starvation condition will result in an ungraceful shutdown of the printing press from which recovery may take hours. For instance, starvation may result in running blank paper, which occasionally can result in an emergency stop. An emergency stop may result in paper fragments scattering throughout the press, potentially contacting hot drying equipment and combusting. Further, ungraceful shut down may result in unintended consequences to not just the press, but also to finishing lines, which may also be time consuming to reset. Additionally, it may be the case that a job manifest is designed to fit within a specific length of roll of print medium. Uncertainty in where a job stopped may result in reprinting the whole manifest, which may consume a new roll of print medium, which may take time to be acclimated to the press environment and loaded into the press. It is to be appreciated that such a long downtime will generate significant amounts of waste as well as loss of printing time. Therefore, a starvation condition is to be avoided if possible.

The manner by which a starvation condition is predicted is not particularly limited. For example, the print engine controller 30 may look at the amount of separations available to be transmitted to the printing device to determine if a starvation condition is likely to occur. If the number of separations stored for transmission is decreasing, a starvation condition may be predicted. In other examples, the print engine controller 30 may use the metrics received from the conversion engine 20 and/or the compression engine 25 to predict the starvation condition. For example, if the metrics suggest that the processes at the conversion engine 20 and/or the compression engine 25 are too slow, the information may be used to implement corrective actions to minimize disruption at the printing device.

The corrective actions taken by the print engine controller 30 are not particularly limited. For example, the print engine controller 30 may take no corrective actions and simply make the prediction of a starvation condition. The print engine controller 30 may then generate an alarm or alert to an operator such that manual intervention is taken to avoid an ungraceful shutdown. As an example of a possible corrective action, the print engine controller 30 may be used to control the speed of the printing device. In particular, the print engine controller 30 may be used to slow down the printing device to allow the image pipeline more time to process the document data prior to sending the data to the printing device. It is to be appreciate that to slow the printing device, the downtime used to power down and start up the printing device may be saved. As another example, the prediction of a starvation condition may be used to gracefully shut down the printing device to avoid damaging any of the hardware.

In another example, the print engine controller 30 may signal the front-end engine 15 to increase the processing speed of the front-end engine 15. That is, the front-end engine 15 may be normally operated at a lower than maximum rate through, for example, controlling a variable speed processor, controlling power management of a processor, or similar techniques. Controlling a chunking process, such as by setting chunk size, may be used to control processing rate of the front-end engine 15. The processing rate of the front-end engine 15 may be increased when the print engine controller 30 predicts a starvation condition. Such an increase may be temporary and may supplement a slowing of the printing device.

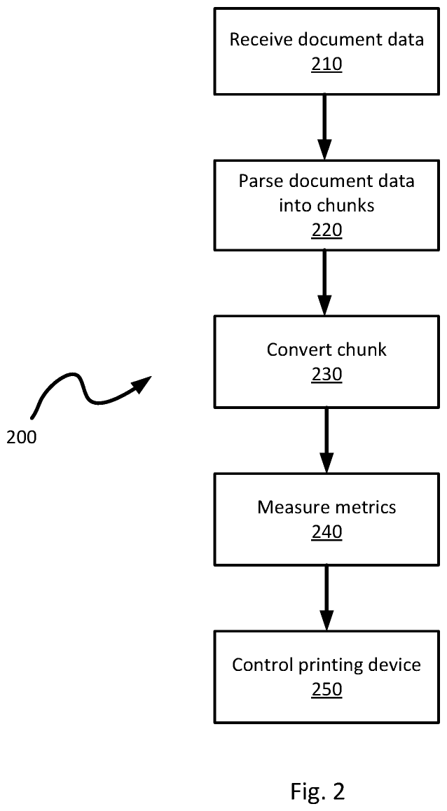

Referring to FIG. 2, a flowchart of a method to operate a printing press is shown at 200. In order to assist in the explanation of method 200, it will be assumed that method 200 may be performed with the apparatus 10. Indeed, the method 200 may be one way in which apparatus 10 may be configured. Furthermore, the following discussion of method 200 may lead to a further understanding of the apparatus 10 and its various components. Furthermore, it is to be emphasized, that method 200 may not be performed in the exact sequence as shown, and various blocks may be performed in parallel rather than in sequence, or in a different sequence altogether.

Beginning at block 210, the front-end engine 15 receives document data for printing. The format of the document data received is not particularly limited. In the present example, the document data is a page-oriented data file representing a plurality of pages to be printed. For example, the pages represented by the document data may be sequential, or the pages may be odd or even pages.

In block 220, the front-end engine 15 parses the document data into a plurality of chunks prior to forwarding the document data to the next portion of the image pipeline. In the present example, each chunk may include a plurality of pages and represent a unit of work in some examples. In the other examples, the document data as a whole may be a single chunk.

The manner by which the data document is divided into chunks is not necessarily limited. In the present example, the document data comprises a data file having a plurality of pages. The document data may be divided into subsets such that each chunk represents a group of pages selected from the plurality of pages. The size of each chunk may be determined base on a chunking optimization process such that the size is set to the optimal size dependent on the characterization of the apparatus 10. For example, the chunking algorithm may divide the document data into a plurality of chunks for multiple processing in an apparatus 10 with multiple conversion engines or compression engines as discussed in greater detail below.

Block 230 converts a chunk generated at block 220 from the page-oriented format into an uncompressed format. In the present example, the chunk is passed from the front-end engine 15 to the conversion engine 20 for the conversion. For example, the conversion engine 20 may receive a chunk of a PDF data file and convert the PDF data file into a raw image format or a raster file format.

Block 240 measures metrics of the conversion process of the chunk from the page-oriented format to the uncompressed format by the conversion engine 20. The metrics that are measured are not particularly limited and may include information such as sped of the conversion process, such as the amount of time used to convert an unit of area on each page, the compression ratio of the page-oriented format, the amount of memory used in the conversion process, the amount of processor resources used, the number of fonts used on the page, the number of shaded fill objects, separations not blank, the inclusion of transparency on the page, the number of images on the page, and the like.

The manner by which the metrics are measured is not particularly limited. For example, the conversion engine 20 may automatically generate metadata that includes the metrics. In such an example, block 240 may simply read the metadata generated and report the metadata as the metric. In other examples, the conversion engine 20 may operate a measurement routine that monitors the performance of the conversion engine 20 to determine the metrics.

Next, the print engine controller 30 carries out block 250 to control a printing device based on the metrics measured at block 240. In particular, the print engine controller 30 uses the metrics to avoid a starvation condition at the printing device. In general, a starvation condition may occur when the print engine controller 30 does not provide sufficient document data to the printing device to maintain the speed at which paper is fed through the printing device. Accordingly, the paper may arrive and pass over the printhead without the printing device having any data to control the printhead. In such a situation, the printing device may be stopped ungracefully due to an error condition as the paper moves through the printer that it cannot be mechanically stopped.

The manner by which a starvation condition is avoided is not particularly limited. For example, the print engine controller 30 may look at the amount of document data available to be transmitted to the printing device to determine if a starvation condition is likely to occur. If the amount of document data, such as chunks, stored in a buffer is decreasing at a faster rate than the rate at which chunks replenish the buffer, a starvation condition may be predicted. However, it is to be appreciated that by the time the print engine controller 30 recognizes that the buffer is too low, it may be too late to take corrective actions. In the present example, examples, the print engine controller 30 also uses the metrics received from the conversion engine 20 to predict the starvation condition. For example, if the metrics suggest that the processes at the conversion engine 20 are too slow, the information may be used to implement corrective actions earlier to minimize disruption at the printing device.

The corrective actions taken by the print engine controller 30 are not particularly limited. The print engine controller 30 may generate an alarm or alert to an operator such that manual intervention is taken to avoid an ungraceful shutdown. For example, the operator may implement a shutdown procedure or make hardware changes to the apparatus. As another example of a corrective action, the print engine controller 30 may automatically control the speed of the printing device. In particular, the print engine controller 30 may slow the printing device to allow the image pipeline more time to process the document data prior and replenish the buffer prior to having the document data in the buffer reach critically low levels. As another example, the print engine controller 30 may also gracefully shut down the printing device to avoid damaging any of the hardware when it is determined that the buffer cannot be replenished even if the printing device is operating at a minimum speed.

Variations to the above method are contemplated. For example, in the present example, the uncompressed format may be provided to the print engine controller 30 for transmitting to printing device. In other examples, each chunk of document data in the uncompressed format may be compressed using a compression engine 25 as described in greater detail above. Furthermore, it is to be appreciated that in examples where the chunks are recompressed using another compression format, such as an Indigo Compression Format, additional metrics may be generated and measured by block 240. It is to be appreciate that these additional metrics may be used to further predict and avoid a starvation condition.

The above method may be applied to a multi-lane print architecture, in which multiple parallel user jobs are processed across a wide web. The starvation prediction methodology described herein may be used across a such a web. For example, the data captured and metric-based decisions made may be such that any lane of data that is determined to be approaching starvation may trigger corrective action.

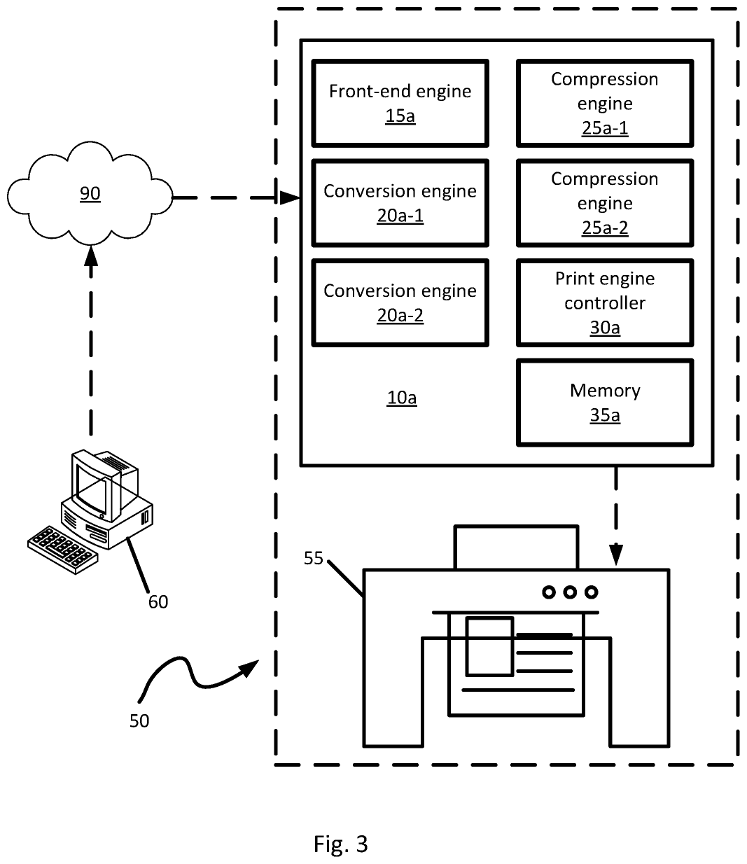

Referring to FIG. 3, an example of a printing press system is shown at 50. The printing press system 50 includes a printing device 55 and an apparatus 10a for operating the image pipeline. In the present example, the printing press system 50 may receive document data from a client machine 60 via a network 90. Like components of the apparatus 10a bear like reference to their counterparts in the apparatus 10, except followed by the suffix “a”. The apparatus 10a includes a front-end engine 15a, a plurality of conversion engines 20a-1 and 20a-2 (generically, these databases are referred to herein as “conversion engines 20a” and collectively they are referred to as “conversion engines 20a”, this nomenclature is used elsewhere in this description), a plurality of compression engines 25a-1 and 25a-2, a print engine controller 30a, and a memory 35a.

The front-end engine 15a is to receive document data for printing. In the present example, the document data is received via the network 90 from the client machine 60. Accordingly, the front-end engine 15a may include a network interface card or wireless antenna to send and receive data via the network 90. The client machine 60 is not limited and may be any may be any device capable of generating document data. Although the present example shows the client machine 60 as a terminal computer or a desktop computer, the client machine 60 may be substitute with another document data source. For example, the client machine may be another server providing document data. In the present example, the format of the document data received is not particularly limited and may include document data in various formats previously discussed in connection with the apparatus 10.

The conversion engines 20a are each in communication with the front-end engine 15a. After receiving the document data, the front-end engine 15a may divide the document data into a plurality of chunks as described above. It is to be appreciate that the chunks may be passed separately to the conversion engines 20a for parallel processing. Once the conversion engines 20a receive the chunk of document data, the conversion engines 20a carry out a conversion of the chunk of the document data from the received format to an uncompressed format, such as raw image format or a raster file format.

In the present example, the conversion engines 20a also measure and/or generate metrics associated with the conversion process of each of the chunks of the document data from the page-oriented format to the uncompressed format. For example, the metrics may include the time used by the conversion engines 20a to convert the document data or chunk of document data from the page-oriented format to the uncompressed format. In other examples, the metrics may include the compression ratio of the page-oriented format, the amount of memory used in the conversion process, or the amount of processor resources used. Once generated, the metrics may be transmitted from each of the conversion engines 20a to the print engine controller 30a.

After converting the document data to an uncompressed format, the conversion engines 20a separate the chunks into a plurality of separations. The separation process is not particularly limited. For example, conversion engine 20a may generate all separations for a page or fewer than all separations for a page. Moreover, multiple conversion engines 20a may produce one separation, for instance. In addition, a separation may be stored in any number of files. For example, a large or parallel-processed separation may be segmented into multiple files that are stored and processed separately. A separation from the plurality of separations may represent a portion of a page within a chunk of the document data.

The compression engines 25a are to process the separations created by the conversion engines 20a. It is to be appreciate that the separations may be allocated between the two compression engines 25a in the present example for parallel processing. The manner by which the separations are divided is not particularly limited and may include a load balancing analysis to determine an efficient way to distribute the separations. It is to be appreciated that since the chunks parsed by the front-end engine 15a are further parsed by the conversion engine 20a into separations, the number of separations is generally larger than the number of chunks.

In the present example, the compression engines 25a are to convert the separations in the uncompressed format to another format that is associated with the printing device 55. The format associated with the printing device 55 is not particularly limited and may be predetermined based on the known format or formats that are associated with the printing device 55. In the present example, the format associated with the printing device 55 is a lossy compression format tuned to human vision. The lossy compression is used to reduce storage consumption as well as additional hardware. In the present example, the specific lossy compression used by the compression engines is Indigo Compression Format.

In some examples, the compression engines 25 may also generate metrics associated with the compression process of the separations from the uncompressed format to the format associated with the printing device. For example, the metrics may include the time used by the compression engines 25a to convert each separation, or a plurality of separations representing a chunk of the document data, from the uncompressed format to the format associated with the printing device. In other examples, the metrics may include the compression ratio of the format associated with the printing device, the amount of memory used in the conversion process, the amount of processor resources used, or similar as discussed elsewhere herein. Once generated, the metrics from the compression engines 25a may be transmitted to the print engine controller 30a.

The print engine controller 30a is to transmit the separations which have been converted to the format associated with the printing device 55. In the present example, the print engine controller 30a is to send the separations to the printing device 55 where the printing device generates output corresponding to the separations. The manner by which the print engine controller 30a transmits document data to the printing device is not limited and may include the methods discussed above in connection with the print engine controller 30.

Furthermore, the print engine controller 30a is to predict a starvation condition at the printing device 55. A starvation condition occurs when the print engine controller 30a does not have any separations or document data to send to a printing device 55 in motion. In particular, if the print engine controller 30a has no more data to send to the printing device 55, the printing device 55 will face an error condition where there is nothing to be printed. The manner by which a starvation condition is predicted is not particularly limited. For example, the print engine controller 30a may look at the amount of separations available to be transmitted to the printing device 55 to determine if a starvation condition is likely to occur. If the number of separations stored in the memory 35a for transmission is decreasing, a starvation condition may be predicted. In other examples, the print engine controller 30a may use the metrics received from the conversion engines 20a and/or the compression engines 25a to predict the starvation condition. For example, if the metrics suggest that the processes at the conversion engines 20a and/or the compression engines 25a are too slow, the information may be used to implement corrective actions to minimize disruption at the printing device 55.

The memory 35a may be coupled to the front-end engine 15a, the conversion engines 20a, the compression engines 25a, and the print engine controller 30a. The memory 35a may further include a non-transitory machine-readable storage medium that may be any electronic, magnetic, optical, or other physical storage device. The non-transitory machine-readable storage medium may include, for example, random access memory (RAM), electrically-erasable programmable read-only memory (EEPROM), flash memory, a storage drive, an optical disc, and the like. The machine-readable storage medium may be encoded with executable instructions to operate the apparatus 10a. The operating system that is executable by various components of the apparatus 10a to provide general functionality, for example, functionality to support various applications to access various features of the apparatus 10a. Examples of operating systems include Windows™, macOS™, OS™, Android™, Linux™, and Unix™. The memory 35a may additionally store applications that are executable by one or more of the engines in the apparatus 10a to provide specific functionality, such as functionality to receive and handle document data or to transmit separations to the printing device 55.

In the present example, the memory 35a stores the document data at various stages of processing. For example, the memory may store the data file received at the front-end engine 15a as well as the plurality of chunks and the plurality of separations. In addition, the memory 35a may maintain a buffer of separations for sending to the printing device 55. The size of the buffer is not limited, and it is to be understood that increasing the size of the buffer may provide additional warning time of an imminent starvation condition at the cost of additional computer resources. The memory 35a may also store executable instructions. For example, the executable instructions may include a set of instructions to carry out the method 200.

Variations to the printing press system 50 and the apparatus 10a are contemplated. For example, although two conversion engines 20a and illustrated, it is to be appreciated that more conversion engines 20a may be added to the apparatus 10a to increase the parallel processing power of multiple chunks. Similarly, although two compression engines 25a and illustrated, it is to be appreciated that more compression engines 25a may be added to the apparatus 10a to increase the parallel processing power of multiple separations. Furthermore, since each chunk may be parsed into multiple separations, it is to be understood that more separations may be processed than the number of chunks processed.

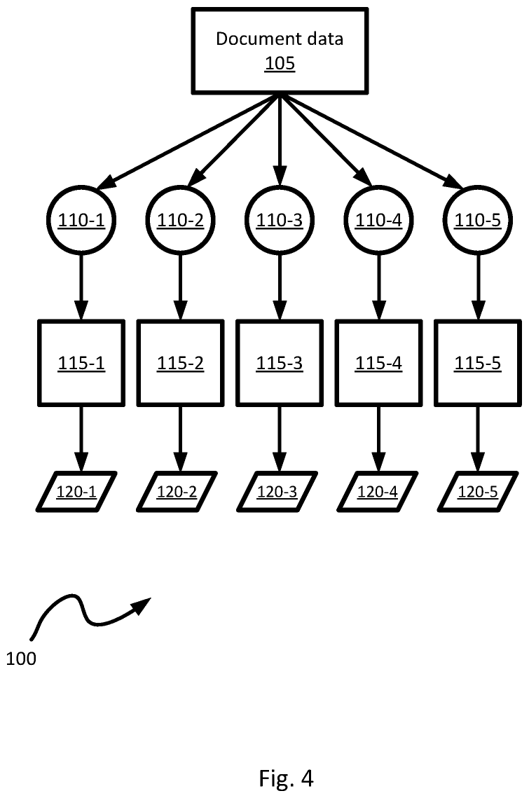

FIG. 4 shows an example 100 of document data 105 in an image pipeline. In order to assist in the document data 105 as it passes through the image pipeline, it will be assumed that the document data 105 is provided to the apparatus 10. Furthermore, the following discussion of the document data 105 may lead to a further understanding of the apparatus 10 and its various components as well as the method 200.

Upon arrival at the front-end engine 15, the document data 105 may be a single file having a page-oriented format, such as PDF. The front-end engine 15 may parse the document data 105 into a plurality of chunks 110-1, 110-2, 110-3, 110-4, 110-5. The manner by which the document data 105 is parsed is not limited and may involve a chunking algorithm to optimize the size of each chunk for the apparatus 10. Subsequently, each of the chunks 110 are converted by the conversion engine 20 into a plurality of chunks 115-1, 115-2, 115-3, 115-4, 115-5, respectively, in an uncompressed format such as a raw image format or a raster file format. The plurality of chunks 115 in the uncompressed format are then compressed by the compression engine 25 using a lossy compression method to provide compressed chunks 120-1, 120-2, 120-3, 120-4, 120-5, respectively, of the document data 105 in a different format.

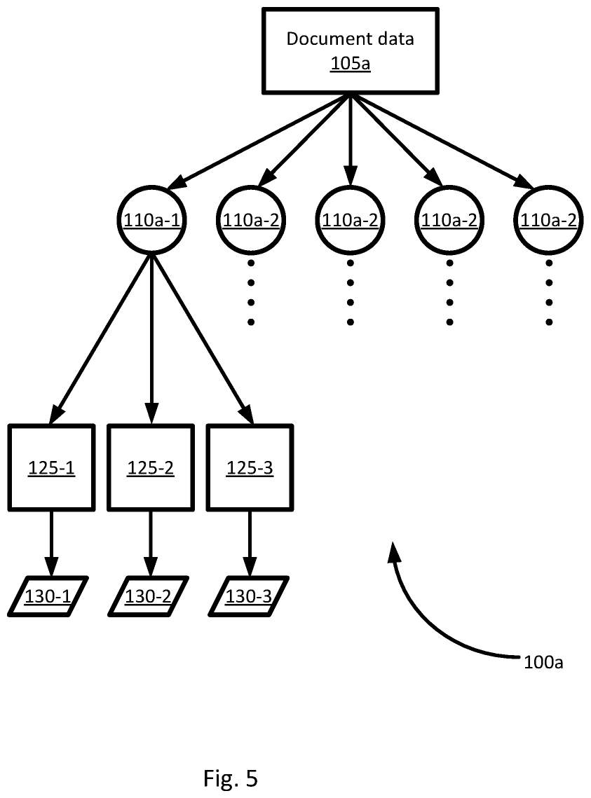

FIG. 5 shows another example 100a of document data 105a in an image pipeline. In order to assist in the document data 105a as it passes through the image pipeline, it will be assumed that the document data 105a is provided to the apparatus 10. Furthermore, the following discussion of the document data 105a may lead to a further understanding of the apparatus 10 and its various components as well as the method 200.

Upon arrival at the front-end engine 15, the document data 105a may be a single file having a page-oriented format, such as PDF. The front-end engine 15 may parse the document data 105a into a plurality of chunks 110a-1, 110a-2, 110a-3, 110a-4, 110a-5. The manner by which the document data 105a is parsed is not limited and may involve a chunking algorithm to optimize the size of each chunk for the apparatus 10. Subsequently, each of the chunks 110 are converted by the conversion engine 20 into a plurality of chunks in an uncompressed format such as a raw image format or a raster file format and further parsed into a plurality of separations 125-1, 125-2, 125-3. The plurality of separations 125 in the uncompressed format are then compressed by the compression engine 25 using a lossy compression method to provide compressed separations 125-1, 125-2, 125-3, respectively, of the document data 105a in a different format. Separations 125-1, 125-2, 125-3 may be processed or stored as compressed chunks 130-1, 130-2, 130-3. It is to be appreciated that each of the remaining chunks 110a-2, 110a-3, 110a-4, 110a-5 are similarly parsed into separations. The number of chunks and separations is not limited. For example, the front-end engine 15 may divide the document data 105a into more or less than five chunks as shown in FIG. 5. Each of the chunks 110a may be different in sized depending on the content of the document data 105. Similarly, the conversion engine 20 may divide each chunk 110a into more or less than three separations as shown.

It should be noted that the size of a chunk may not be static and may be dynamic. Chunking may use small chunks early on, so as to fill a print engine's buffer quickly, then switch to longer chunks to lower a transaction cost of starting and stopping chunks. Towards the end of a file, chunks may again be made small.

It should be apparent from the above, that a variable number of pages may be stored in a finite amount memory of a printing press system, as pages may have variable complexity and thus variable storage consumption. Blank pages or pages of low-information density, which take little space, may be stored in great quantity. Visually complex pages, which may be slow to process, may be stored in relatively limited quantity. Page images may flow through the memory at real-time or near real-time, when the press is in continuous operation. Hence, the relatively less time and space available for processing of complex pages may be predicted and corrected for using image processing metrics. This may reduce the complexity of the printer and improve its performance.

It should be recognized that features and aspects of the various examples provided above may be combined into further examples that also fall within the scope of the present disclosure.

What is claimed is:

1. An apparatus comprising:
a front-end engine to receive document data in a first format for printing via a network;
a conversion engine in communication with the front-end engine, the conversion engine to carry out a conversion of the document data from the first format to an uncompressed format, wherein the conversion engine generates metrics associated with the conversion, the conversion engine to parse the document data in the uncompressed format into a plurality of separations;
a compression engine to process a separation of the plurality of separations from the uncompressed format to a second format, wherein the second format is a predetermined format associated with a printing device; and
a print engine controller to transmit the separations in the second format to the printing device, wherein the print engine controller uses the metrics to predict a starvation condition at the printing device.

2. The apparatus of claim 1, wherein the first format is a page-oriented format, wherein the document data represents a plurality of pages to be printed.

3. The apparatus of claim 2, wherein the metrics include a compression ratio.

4. The apparatus of claim 2, wherein the metrics include a raster image processing time to convert the document data from the first format to the uncompressed format.

5. The apparatus of claim 4, wherein the metrics include a compression time to compress the separation from the uncompressed format to the second format.

6. The apparatus of claim 1, wherein the print engine controller to control a speed of the printing device.

7. The apparatus of claim 6, wherein the print engine controller reduces the speed of the printing device based on the metrics.

8. A non-transitory machine-readable storage medium encoded with instructions executable by a processor, the non-transitory machine-readable storage medium comprising:
instructions to receive document data via a front-end engine in a first format for printing;
instructions to parse the document data into a plurality of chunks;
instructions to convert a chunk from the plurality of chunks, wherein the instructions convert the chunk from the first format to an uncompressed format;
instructions to measure metrics associated with a conversion of the chunk; and
instructions to transmit the metrics to a print engine controller to avoid a starvation condition.

9. The non-transitory machine-readable storage medium of claim 8, wherein the first format is a page-oriented format, wherein the document data represents a plurality of pages to be printed, and wherein the chunk represents a plurality of pages.

10. The non-transitory machine-readable storage medium of claim 8, comprising instructions to pre-estimate an estimated raster image processing time, wherein the estimated raster image processing time is to be used to generate the plurality of chunks such that each chuck has a substantially similar raster image processing time.

11. The non-transitory machine-readable storage medium of claim 8, wherein the metrics include a raster image processing time to convert the chunk from the first format to the uncompressed format.

12. The non-transitory machine-readable storage medium of claim 11, wherein the metrics include a raster image processing time to convert the chunk from the first format to the uncompressed format.

13. A method comprising.
receiving document data at a front-end engine in a first format for printing;
parsing the document data into a plurality of chunks;
converting a chunk from the plurality of chunks from the first format to an uncompressed format;
measuring metrics associated with a conversion of the chunk; and
controlling a printing device based on the metrics to avoid a starvation condition.

14. The method of claim 13, wherein controlling comprises reducing a speed of the printing device when the starvation condition is predicted.

15. The method of claim 14, wherein controlling further comprises increasing a processing rate of the front-end engine.
